(19) United States
(12) Patent Application Publication
(10) Pub. No.: US 2004/0035683 A1
(43) Pub. Date: Feb. 26, 2004

(54) Roller drive unit

(76) Inventor: Thomas Huber, Schliersee (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/611,495

(22) Filed: Jul. 1, 2003

(30) Foreign Application Priority Data
Jul. 1, 2002 (DE) 102 29 539.5

(51) Int. Cl. B65G 13/02

(52) U.S. Cl. 198/780; 198/782; 193/37; 492/56

(57) ABSTRACT

A roller drive unit for transporting items of freight in an aircraft cargo hold is provided in which a drive motor is coupled to a drive roller. The drive roller comprises a core and a covering fastened thereto that has an outer surface that can be brought into frictional contact with a bottom of an item of freight in order to transport said item. So that high durability can be achieved even when the material used for the covering is relatively soft, it is proposed that the covering should comprise at least one delimiting layer, so constructed and so disposed between at least one inner covering layer and an outer covering layer that on one hand the covering layers are firmly connected to one another and on the other hand a spreading of a fissure from the one covering layer into the other covering layer is limited.

### FIELD OF THE INVENTION

The present invention relates to a roller drive unit for use in the transportation of items of freight in an aircraft cargo hold.

### BACKGROUND OF THE INVENTION

Roller drive units of this kind, for transporting items of freight within the cargo hold of an aircraft, are known in a large number of embodiments, for example as described in patents DE 41 02 424 and U.S. Pat. No. 3,712,454.

A substantial problem in providing equipment for aircraft is that the time required for maintenance or replacement can entail enormous costs. This applies in particular to the loading regions of aircraft. The problem is exacerbated by the fact that in these regions the environmental conditions are extremely harsh and operating conditions are also severe, because in highly diverse climate zones the operations must always be carried out at the greatest possible speed and hence, quite often, not as carefully as would be desired. The bottom regions of freight items being loaded with such roller drive units are frequently damaged by rough handling, so that the covering of any roller is exposed to the action of punctate cutting or scratching forces. Another difficulty is that loads are imposed on the drive rollers, and hence their covering, from various directions, especially when a container is being rotated within the cargo hold. Furthermore, elevated temperatures can occur, in particular when the drive roller slips against a surface, which can easily happen when the drive rollers swing upward automatically while an item of freight is just above them or when movement of the freight becomes blocked.

Because of the stresses to which the drive rollers are exposed, their outer coating or covering tends to be torn away after a relatively brief period of operation of typically within only 1 to 2 years. That is, the covering is not gradually worn down, so that after a sufficiently long duration of use the drive rollers can be exchanged. Instead, damage occurs abruptly and can be severe enough to make the drive rollers nonfunctional.

Attempts to solve the above problems by using covering materials that are more stable and resistant to wear and tear have failed because such drive rollers can be pressed against the freight items with only a limited amount of force and the material must be relatively soft in order to ensure a sufficiently high degree of frictional engagement.

### BRIEF SUMMARY OF THE INVENTION

Starting from the state of the art as described above, it is the object of the present invention to provide a roller drive unit of the kind cited at the outset that has an enhanced operating performance is ensured, while its traction properties remain unaltered.

According to the present invention there is provided a roller drive unit for transporting an items of freight in an aircraft cargo hold comprising a drive roller comprising a core and a covering attached thereto defining an outer surface that can be brought into frictional contact with a bottom of an item of freight in order to transport said item; and a drive motor coupled to the drive roller to rotate the drive roller about its long axis; wherein the covering comprises a plurality of covering layers including an outer covering layer, at least one inner covering layer, and at least one delimiting layer that is so constructed and disposed between at least one of the inner covering layers and the outer covering layer that the inner and outer covering layers are firmly connected to one another and that a spreading of a fissure from the one covering layer into an adjacent covering layer is restricted.

Hence, although the roller surface repeatedly and unavoidably becomes torn during use, such a tear cannot cause the entire covering surface to break apart but is merely capable of separating component pieces. That is, according to the present invention the delimiting layer does not represent a reinforcing layer in the actual sense, because it affects neither the covering surface, which comes into frictional engagement with the items of freight to be conveyed, nor the stability of the layer as a whole or its attachment to the core.

The covering layers are preferably designed to be concentric with the outer surface of the drive roller, so that a symmetrical construction is produced. Alternatively, and in particular when a plurality of delimiting layers are disposed between a plurality of covering layers, it is possible to construct the outer part of the drive roller, i.e. the entire covering, as a band comprising a delimiting layer and a covering layer (or integral multiples thereof), to wind this band onto a core, and finally to shape it so that it is concentric with the core, for example by polymerization or vulcanization.

Each delimiting layer preferably comprises openings, pores or similar perforating structures through which material pertaining to the adjacent covering layers can come into direct contact. What is important here is that the structure should be such that despite the presence of an intervening structure, separation of the covering layers by the delimiting layer is made practically impossible; the openings/pores must be of a size such that precisely this adherence of the covering layers to one another is ensured and nevertheless the “fissure-restricting” action of the delimiting layer is maintained.

The delimiting layer can be constructed in diverse forms. In a particularly simple construction, it is a woven layer with a relatively coarse structure such that the above-mentioned connection of the covering layers to one another is ensured. This is especially easy to achieve with a single-ply weave.

When a plurality of such delimiting layers is provided, preferably substantially equidistant from one another, despite normal wear and tear that reduces the roller diameter it is possible for the effect of the invention to be maintained over a considerable period of operation, i.e. for tearing of the covering layers to be restricted. In this case when the delimiting layers are exposed by abrasion during use, they can be rubbed off, whereupon a “fresh” underlying covering layer is exposed. It is also possible while servicing the roller drive unit to “overspeed” the drive rollers so as to deliberately cause a layer of specified thickness to be abraded.

Another possibility for restricting to a tolerable level the initially described tearing-out of adequately soft and flexible material can be implemented by providing, in addition to the delimiting layers, delimiting walls in the material layers that extend in the direction of the long axis and/or radial thereto and are so constructed that regions of the covering layers are firmly connected to one another by the delimiting walls. This measure, again, turns on the idea of using sufficiently elastic covering material, which will practically inevitably be torn when exposed to certain kinds of loads (cuts or the like), but restricting the damage by providing delimiting walls or layers that “intercept” the resulting fissures and thus restrict the size of the piece of covering material that breaks away. In this case, however, the delimitation operates not in the direction from outside inward, toward the long axis of the drive roller, but instead acts in superficial regions, i.e. region of the covering surface extending in the long direction and/or circumferentially around the covering. The characteristics and special embodiments described above for the delimiting layers also apply here.

Altogether, the covering layers here are preferably made of rubber or similar vulcanizable material or polymerizing material, as is known per se.

Regarding the method, the covering layers are preferably produced as flat elements consisting of un- or partially-polymerized rubber, which are wound around the core, with the delimiting layers between covering layers, and then cured in a mold by (thermal) vulcanization. This winding can be done in several turns so as to produce a multiple-ply structure, resulting in a spiral configuration of the delimiting layer. It is of course important here that ultimately the peripheral surface is absolutely cylindrical and coaxial with the core and is fixed in this shape by the subsequent vulcanization/polymerization.

The invention will now be described by way of example with reference to the accompanying drawings.

### BRIEF DESCRIPTION OF THE SEVERAL VIEWS OF THE DRAWINGS

FIG. 1 is a perspective drawing of a drive roller according to the invention with a covering shown partly cut away;

FIG. 2 is a sectional view of part of two adjacent covering layers with a delimiting layer between them; and

FIG. 3 is a perspective view of a plurality of covering layers showing delimiting layers.

### DETAILED DESCRIPTION OF THE INVENTION

In the following description, the same reference numerals are used for identical parts or parts with identical actions.

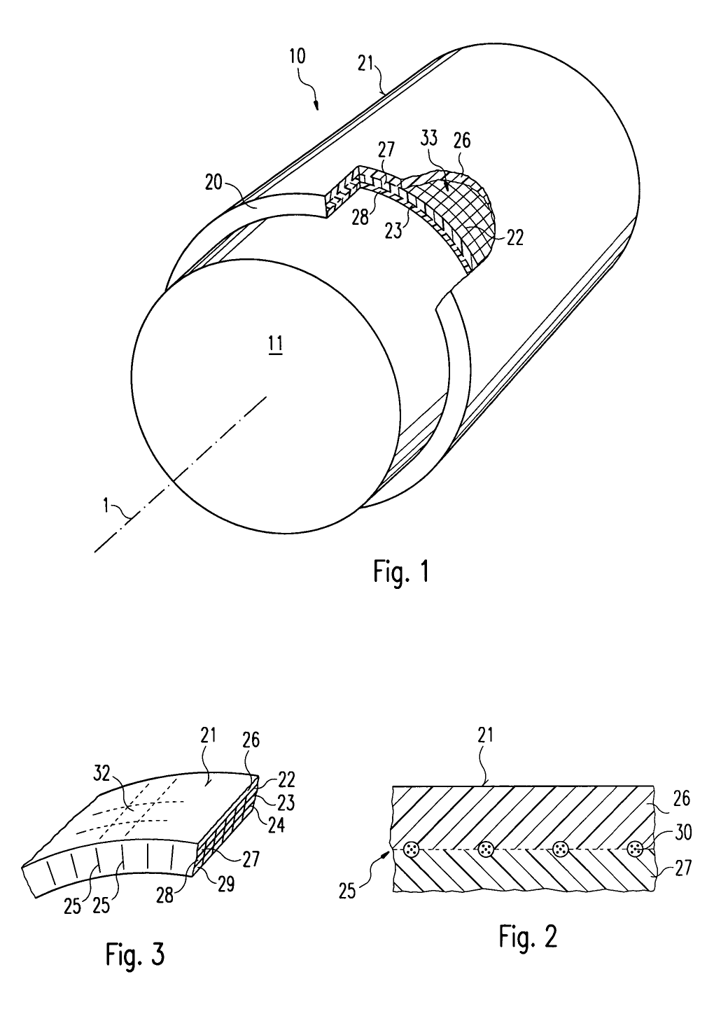

As shown in FIG. 1, a drive roller 10 that can rotate about a long axis 1 comprises a core 11 and a covering 20 made of rubber that is attached thereto, in particular by vulcanization. When freight items are being transported, an outer surface 21 of the covering 20 comes into frictional contact with the undersurface of these items, as is known in the state of the art.

The covering 20 in the exemplary embodiment shown in FIG. 1 comprises an innermost covering layer 28, which is vulcanized directly onto the core 11. On the surface of the innermost covering lies an inner delimiting layer 23, on which in turn an inner covering layer 27 lies. On the inner covering layer 27 lies another delimiting layer 22, on which lies an outer covering layer 26, the surface of which that faces away from the core 11 constitutes the outer surface 21.

All of the covering layers 26, 27, 28 and 29 (the last of these is shown only in the FIG. 3 embodiment) are connected to one another in the manner illustrated in part in FIG. 2: the various covering layers 26 to 29 are joined in such a way that the material of which they are composed is continuous. This is brought about in a manner known per se, by vulcanization of rubber material or curing of plastic material by polymerization.

Between the covering layers 27 to 29 are disposed delimiting layers 22 to 24, which in the example shown here comprise a rough textile material such as bagging or sack cloth that is woven from threads 20. It is of course also possible to construct this layer according to another technology; the crucial point is always to obtain a structure that—as shown in FIG. 1—comprises a large number of openings 33, so that the covering layers 26 to 29 can become firmly connected to one another. The delimiting layers 22 to 24 thus do not constitute a reinforcement of the covering material in the actual sense, but instead serve exclusively to prevent fissures in the outer surface 21 from extending toward the core 11, or in any case to limit their extent. As material for the threads 20 a textile material can be used, also in particular a carbon-fiber material. It is also possible to use monofilament lattice structures as delimiting layers 22 to 24.

In the embodiment shown in FIG. 3 are provided, in addition to the delimiting layers 22 to 23, delimiting surfaces 25 in the nature of walls that are disposed in the radial direction and in the circumferential direction with respect to the core 11, i.e. its long axis 1, so that circumscribed regions 32, indicated in FIG. 3 by the broken lines, are produced. Hence by means of these delimiting surfaces 25 a spreading of fissures and fractures parallel to the outer surface 21, i.e. both in the circumferential direction and also in the direction of the long axis 1, is limited to the circumscribed regions 32. The detachment of larger surface regions is thus effectively prevented.

It will be evident from the above description that even when relatively soft, elastic covering material is used, which thus offers good frictional properties for the drive roller, the durability of the drive roller 10 can be increased.

1. Roller drive unit for transporting an item of freight in an aircraft cargo hold comprising:
a drive roller comprising a core and a covering attached thereto defining an outer surface that can be brought into frictional contact with a bottom of an item of freight in order to transport said item; and
a drive motor coupled to the drive roller to rotate the drive roller about its long axis;
wherein the covering comprises a plurality of covering layers including an outer covering layer, at least one inner covering layer, and at least one delimiting layer that is so constructed and disposed between at least one of the inner covering layers and the outer covering layer that the inner and outer covering layers are firmly connected to one another and that a spreading of a fissure from the one covering layer into an adjacent covering layer is restricted.

2. Roller drive unit as claimed in claim 1, wherein the covering layers are constructed to be concentric with the outer surface.

3. Roller drive unit as claimed in claim 1, wherein each delimiting layer defines openings through which material forming the adjacent covering layers can come into direct contact.

4. Roller drive unit as claimed in claim 1, wherein each delimiting layer comprises a woven fabric.

5. Roller drive unit as claimed in claim 4, wherein the woven fabric comprises a single ply.

6. Roller drive unit as claimed in claim 1, wherein a plurality of delimiting layers is provided, superimposed such that they are substantially equidistant from one another.

7. Roller drive unit as claimed in claim 1, wherein in addition to the delimiting layers there are provided delimiting surfaces forming walls in the covering layers that extend in the direction of at least one of the long axis and radially to the long axis and that are so constructed that regions of the covering layers are firmly connected to one another by the delimiting surfaces.

8. Roller drive unit as claimed in claim 1, wherein the inner and outer covering layers are made of rubber.

9. Roller drive unit as claimed in claim 1, wherein the inner and outer covering layers are made of a material that is as similarly vulcanizable or polymerizable as rubber.

10. Roller drive unit as claimed in claim 1, wherein the inner and outer covering layers comprising individual layers with delimiting layers inserted between them are wound onto the core and subsequently, by penetration of the covering material through the delimiting layers, are connected to one another.
